(19) United States
(12) Patent Application Publication
(10) Pub. No.: US 2022/0043152 A1
(43) Pub. Date: Feb. 10, 2022

(54) OBJECT DETECTION AND TRACKING WITH A DEEP NEURAL NETWORK FUSED WITH DEPTH CLUSTERING IN LIDAR POINT CLOUDS

(71) Applicants: Dalong Li, Troy, MI (US); Ayyoub Rezaeian, Lake Orion, MI (US); Stephen Horton, Rochester, MI (US)

(72) Inventors: Dalong Li, Troy, MI (US); Ayyoub Rezaeian, Lake Orion, MI (US); Stephen Horton, Rochester, MI (US)

(21) Appl. No.: 16/985,579

(22) Filed: Aug. 5, 2020

(51) Int. Cl. G01S 17/66; G01S 7/497; G01S 17/42; G01S 17/931; B60W 60/00; G06N 3/08

(52) U.S. Cl. CPC G01S 17/66; G01S 7/497; G01S 17/42; B60W 2520/00; B60W 60/0025; G06N 3/08; B60W 2420/52; G01S 17/931

(57) ABSTRACT

Object detection and tracking techniques for a vehicle include accessing a deep neural network (DNN) trained for object detection, receiving, from a light detection and ranging (LIDAR) system of the vehicle, LIDAR point cloud data external to the vehicle, running the DNN on the LIDAR point cloud data at a first rate to detect a first set of objects and a region of interest (ROI) comprising the first set of objects, and depth clustering, by the controller, the LIDAR point cloud data for the detected ROI at a second rate to detect and track a second set of objects comprising the first set of objects and any objects that subsequently appear in a field of view of the LIDAR system, wherein the second rate is greater than the first rate, wherein the depth clustering continues until a subsequent second iteration of the DNN is run.

### FIELD

The present application generally relates to autonomous vehicles and, more particularly, to object detection and tracking with a deep neural network (DNN) fused with depth clustering in light detection and ranging (LIDAR) point clouds.

### BACKGROUND

Some vehicles are equipped with an advanced driver assistance (ADAS) or autonomous driving system that is configured to perform one or more assistance or autonomous driving features (adaptive cruise control, lane centering, collision avoidance, etc.). Many of these features utilized deep neural networks (DNNs) and various input data (light detection and ranging (LIDAR) point cloud data, camera images, etc.) to generate determinative outputs, such as object detection/classification. DNNs work well for object detection/classification, but they are computationally intensive and thus may require substantial hardware or processing resources. In addition, DNNs are not ideally suited for object tracking because they are relatively slow, which could decrease performance or increase costs due to the implementation of additional hardware resources (e.g., more expensive processing units. Accordingly, while these conventional systems do work well for their intended purpose, there exists an opportunity for improvement in the relevant art.

### SUMMARY

According to one example aspect of the invention, an object detection and tracking system for an autonomous driving feature of a vehicle is presented. In one exemplary implementation, the system comprises: a light detection and ranging (LIDAR) system configured to capture LIDAR point cloud data external to the vehicle and a controller configured to: access a deep neural network (DNN) trained for object detection, run the DNN on the LIDAR point cloud data at a first rate to detect a first set of objects and a region of interest (ROI) comprising the first set of objects, and depth cluster the LIDAR point cloud data for the detected ROI at a second rate to detect and track a second set of objects comprising the first set of objects and any new objects that subsequently appear in a field of view of the LIDAR system, wherein the second rate is greater than the first rate, wherein the depth clustering continues until a subsequent second iteration of the DNN is run to thereby accurately detect and track the second set of objects with robustness to noise while also reducing hardware requirements corresponding to the DNN.

In some implementations, the depth clustering to detect and track the second set of objects comprises performing a procedure comprising: generating first and second lines from the LIDAR sensor to first and second points in the LIDAR point cloud data for the detected ROI, generating a third line connecting the first and second points, determining an angle between the first and third lines, and determining that the first and second points belong to a same object when the angle exceeds a calibrated threshold. In some implementations, the depth clustering to detect and track the second set of objects comprises performing the procedure for a plurality of pairs of points in the LIDAR point cloud data for the detected ROI.

In some implementations, the controller is further configured to run the DNN again at the first rate to detect a third set of objects and a new or updated ROI comprising the third set of objects. In some implementations, the controller is further configured to associate the second and third sets of objects to synchronize the DNN and depth clustering procedures and obtain a fourth set of objects. In some implementations, the controller is further configured to restart the depth clustering for the new or updated ROI at the second rate to detect and track a fifth set of objects comprising the fourth set of objects and any new objects that subsequently appear in the field of view of the LIDAR system.

In some implementations, the first and second rates are calibrated based on a set of vehicle parameters that affect how aggressive object detection and tracking should be performed. In some implementations, the set of vehicle parameters comprises vehicle speed. In some implementations, the set of vehicle parameters comprises the field of view of the LIDAR system.

According to another example aspect of the invention, an object detection and tracking method for a vehicle is presented. In one exemplary implementation, the method comprises: accessing, by a controller of the vehicle, a DNN trained for object detection, receiving, by the controller and from a LIDAR system of the vehicle, LIDAR point cloud data external to the vehicle, running, by the controller, the DNN on the LIDAR point cloud data at a first rate to detect a first set of objects and a region of interest (ROI) comprising the first set of objects, and depth clustering, by the controller, the LIDAR point cloud data for the detected ROI at a second rate to detect and track a second set of objects comprising the first set of objects and any objects that subsequently appear in a field of view of the LIDAR system, wherein the second rate is greater than the first rate, wherein the depth clustering continues until a subsequent second iteration of the DNN is run to thereby accurately detect and track the second set of objects with robustness to noise while also reducing hardware requirements corresponding to the DNN.

In some implementations, the depth clustering to detect and track the second set of objects comprises performing, by the controller, a procedure comprising: generating first and second lines from the LIDAR sensor to first and second points in the LIDAR point cloud data for the detected ROI, generating a third line connecting the first and second points, determining an angle between the first and third lines, and determining that the first and second points belong to a same object when the angle exceeds a calibrated threshold. In some implementations, the depth clustering to detect and track the second set of objects comprises performing, by the controller, the procedure for a plurality of pairs of points in the LIDAR point cloud data for the detected ROI.

In some implementations, the method further comprises running, by the controller, the DNN again at the first rate to detect a third set of objects and a new or updated ROI comprising the third set of objects. In some implementations, the method further comprises associating, by the controller, the second and third sets of objects to synchronize the DNN and depth clustering procedures and obtain a fourth set of objects. In some implementations, the method further comprises restarting, by the controller, the depth clustering for the new or updated ROI at the second rate to detect and track a fifth set of objects comprising the fourth set of objects and any new objects that subsequently appear in the field of view of the LIDAR system.

In some implementations, the first and second rates are calibrated based on a set of vehicle parameters that affect how aggressive object detection and tracking should be performed. In some implementations, the set of vehicle parameters comprises vehicle speed. In some implementations, the set of vehicle parameters comprises the field of view of the LIDAR system.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a functional block diagram of an example vehicle configured for object detection and tracking according to the principles of the present disclosure;

FIGS. 2A-2B are functional block diagram of example architecture object detection and tracking architectures according to the principles of the present disclosure;

FIGS. 3A-3B are plots of an example light detection and ranging (LIDAR) point cloud and an example depth clustering procedure on a detected region of interest (ROI) of the LIDAR point cloud comprising two separate objects according to the principles of the present disclosure; and

FIG. 4 is a flow diagram of an example object detection and tracking method for an autonomous feature of a vehicle according to the principles of the present disclosure.

### DESCRIPTION

As discussed above, there exists an opportunity for improvement in the art of vehicle object detection and tracking. Accordingly, ADAS and autonomous driving systems and methods having improved object detection and tracking performance are presented. For simplicity, the term “autonomous” will hereinafter be used, but it will be appreciated that this encompasses both fully-autonomous (L3, L4, etc.) and semi-autonomous (e.g., ADAS) features (adaptive cruise control, lane centering, collision avoidance, etc.). The techniques of the present disclosure utilize a DNN trained for object detection to detect a region of interest (ROI) in a LIDAR point cloud, where the detected ROI comprises one or more detected objects. The DNN could be run at a first rate as it is computationally intensive. The output of the DNN (the detected ROI and the one or more detected objects) is then fused with depth clustering, which is run on the output of the DNN at a second (e.g., faster) rate to track the object(s) and to also detect and track any new objects showing up in the field of view.

Once the DNN is run again, an association is performed between the objects detected by the DNN on its subsequent run and the objects that were being detected and tracked during the depth clustering. This effectively synchronizes the DNN and the depth clustering procedures. After this, the depth clustering restarts with all of the associated or verified detected objects. The first and second rates could also be calibrated based on vehicle operating parameters (vehicle speed, LIDAR field of view, etc.). The potential benefits include accurate and noise robust object detection and tracking via the depth clustering tracking along with accurate object detection with reduced hardware or processing requirements of the DNN.

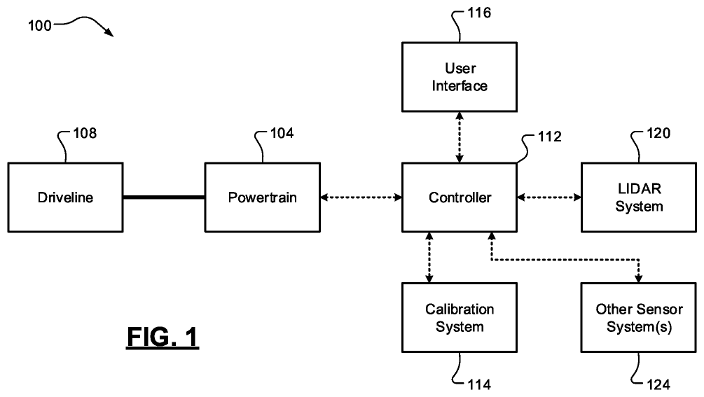

Referring now to FIG. 1, a functional block diagram of an example vehicle 100 having an autonomous driving system according to the principles of the present disclosure. The vehicle 100 comprises a powertrain (an engine, an electric motor, combinations thereof, etc.) that generates drive torque. The drive torque is transferred to a driveline 108 of the vehicle 100 for propulsion of the vehicle 100. A controller 112 controls operation of the powertrain 108 to achieve a desired amount of drive torque, e.g., based a driver torque request provided via a user interface 116 (accelerator pedal, steering actuator, brake pedal, etc.). The controller 112 also implements autonomous driving features.

The autonomous driving system of the present disclosure therefore generally comprises the controller 112, a LIDAR system 120, and one or more other sensor systems 124 (vehicle speed sensor, RADAR, camera system etc.). The LIDAR system 120 is configured to emit light pulses and capture reflected light pulses that collectively form a LIDAR point cloud, with each point in the LIDAR point cloud having corresponding depth information (e.g., based on a wavelength of the reflected light pulse). An external or separate calibration system 114 could also be implemented to train the DNN and upload it to the controller 112. The controller 112 is also configured to perform at least a portion of the object detection and tracking techniques of the present disclosure, which will now be discussed in greater detail.

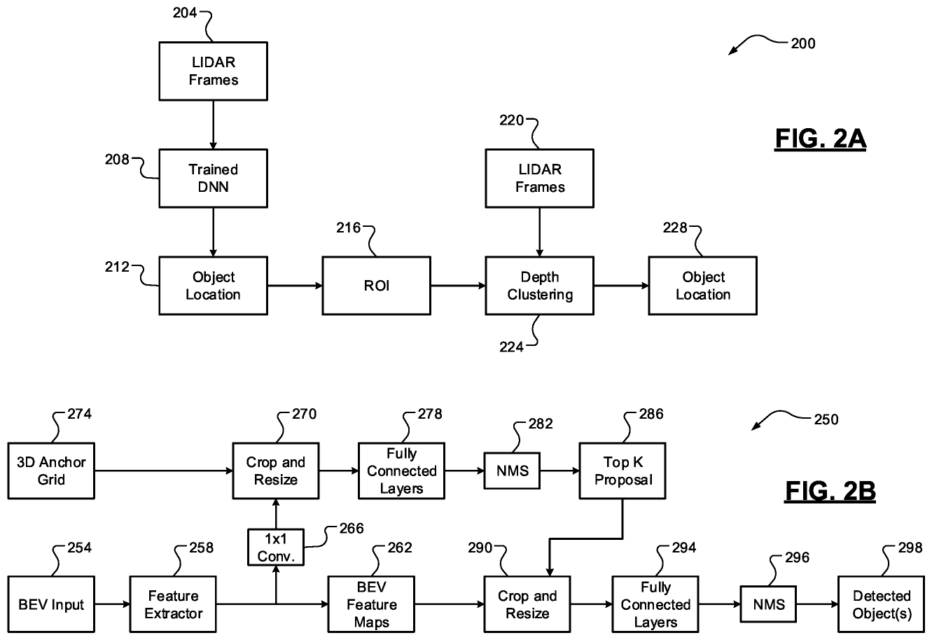

Referring now to FIGS. 2A-2B, functional block diagrams of an example object detection and tracking architectures 200, 250 (e.g., for implementation by the controller 112) according to the principles of the present disclosure is illustrated. In FIG. 2A, the architecture 200 represents DNN-based object detection fused with depth clustering for object tracking. LIDAR frames or point clouds 204 are provided by the LIDAR system 120 as input to a trained DNN 208 for object detection. The trained DNN 208 runs at a first rate and determines both object location(s) 212 and an ROI 216 comprising the object(s) 212. These outputs are then fed to a depth clustering algorithm 224, which also receives the LIDAR frames or point clouds 220 (albeit potentially at a later captured time relative to LIDAR frames or point clouds 204).

This depth clustering 224 runs at a second rate that is in most cases faster than the first rate at which the DNN 208 runs. This is because the depth clustering 224 is very fast and does not require as substantial of processing or hardware resources as the DNN 208. Once the DNN 208 runs again and association/synchronization occurs, the depth clustering 224 will then restart using the updated outputs (ROI and object(s)). The first and second rates are calibratable, and could vary based on various vehicle operating parameters indicative of an aggressiveness of the object detection and tracking. Non-limiting examples of these parameter(s) include vehicle speed and a field of view of the LIDAR system 120. For example, at higher vehicle speeds, the first and/or second rates may be higher.

Referring now to FIG. 2B, one example architecture 250 for the DNN 208 for object detection is illustrated. A bird's eye view (BEV) input 254 (a representation of the LIDAR point cloud data) is provided and feature extraction 258 is performed thereon to identify potential object(s). The extracted features are fed to BEV feature maps 262 where they are compared to known object(s). The output of the feature extractor 258 is also passed through a 1×1 convolutional filter 266 to change the dimensionality of the feature space based on a specific three-dimensional (3D) anchor grid or box 274, which are both provided as inputs to crop and resize the data at 270. The cropped/resized data is then fed through fully connected neural network layers 278, a non-maximum suppression (NMS) 282, and a top K proposal 286 to determine top scored or modeled anchor boxes from the LIDAR point cloud data. This and the output of the BEV feature mapping 262 are fed to another crop/resizing block 290 and then through another set of fully connected neural network layers 294 and another NMS block 296 to finally detect the object(s) 298 in the LIDAR point cloud data. It will be appreciated that this is merely one example architecture 250 for the DNN and that other suitable architectures could be utilized.

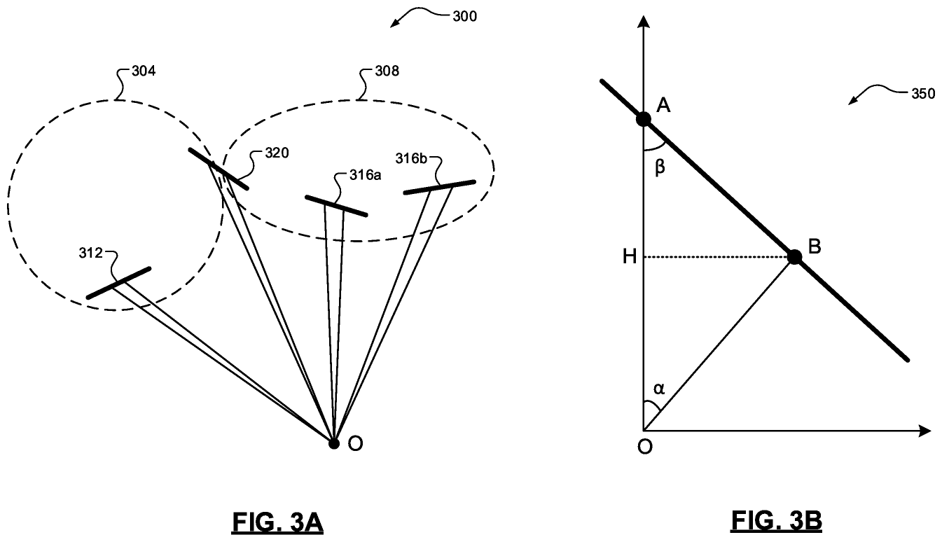

Referring now to FIGS. 3A-3B, plots of an example LIDAR point cloud and an example depth clustering procedure on the detected ROI of the LIDAR point cloud comprising two separate objects according to the principles of the present disclosure is illustrated. In FIG. 3A, the ROI 300 of the LIDAR point cloud is shown. For purposes of this disclosure, circle regions 304 and 308 correspond to two separate objects, and it will be appreciated that the actual LIDAR point cloud data for these objects would include a plurality of dots or points scattered in a relatively dense manner in these respective regions 304, 308. In one exemplary implementation, the depth clustering procedure involves generating lines from the LIDAR sensor 120 (origin point “O”) to pairs of points in the LIDAR point cloud and also generating lines between the respective pairs of points.

In FIG. 3B, one example pair of points A and B are shown, with lines connecting each of these points to the origin point O and also a line connecting points A and B (which should be representative of a surface of the object). Angle α represents and angle between lines OA and OB, whereas angle β represents an angle between line OA and line AB. This second angle β is critical for determining whether points A and B belong to the same object. More particularly, when the angle β is greater than a calibratable threshold angle, points A and B are considered to be part of the same object. Referring back to FIG. 3A, four pairs of points are shown to have been depth clustered. A first pair of points 312 meet the criteria described above and are determined to both be part of object 304. Similarly, second and third pairs of points 316a, 316b both meet the criteria described above and are determined to all be part of object 308.

A fourth pair of points 320, however, does not meet the criteria described above (i.e., angle β is not greater than the calibratable threshold, and thus this pair of points is determined to not be of the same object, which can also be visually seen by the different circular regions 304, 308. By performing this depth clustering across all or a majority of the ROI of the LIDAR point cloud data, and by knowing the object(s) detected by the DNN in the first place, the object(s) can be quickly identified and accurately tracked over time, while also providing a high level of robustness to noise.

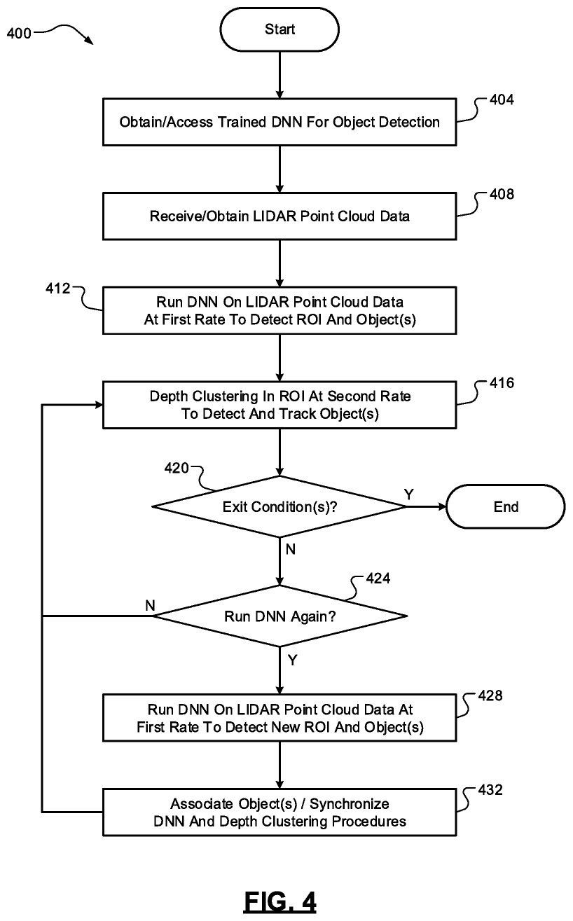

Referring now to FIG. 4, a flow diagram of an object detection and tracking method 400 for an autonomous driving feature of a vehicle (e.g., vehicle 100) according to the principles of the present disclosure is presented. At 404, the controller 112 obtains and accesses a DNN trained for object detection. As previously discussed, the controller 112 could train the DNN or the trained DNN could be provided or uploaded from calibration system 114. At 408, the controller 112 receives LIDAR point cloud data from the LIDAR sensor 120. At 412, the controller runs the DNN on the LIDAR point cloud data at a first rate to detect the ROI therein comprising one or more object(s). This information is then utilized for depth clustering at 416 to identify and track the object(s) in the ROI at a second rate, which is likely faster than the first rate. This depth clustering could also detect and track new objects in the field of view (i.e., since the DNN previously ran). At 420, the controller 112 determines whether an exit conditions have occurred that should cause the method 400 to end. This could include, for example only, the ADAS or autonomous feature being disabled (e.g., the driver being commanded to take control of the vehicle 100).

When true, the method 400 ends or returns and restarts. Otherwise, the controller 112 determines whether it is time to run the DNN again according to the first rate at 424. When false, the method 400 returns to 416 and depth clustering based object detection and tracking continues at the second rate. Otherwise, the method 400 proceeds to 428 where the DNN runs again to detect a new or updated ROI and object(s) therein. At 432, an association between the objects detected by the DNN during this subsequent run and the objects that were previously being detected and tracked by depth clustering is performed. This effectively synchronizes the DNN and depth clustering procedures. The method 400 then returns to 416 where depth clustering restarts using the updated detected objects and ROI at the second rate and the process continues until the exit condition(s) are present.

For example only, assume that the DNN initially detects 5 objects at 412. Depth clustering is then performed at 416 to begin detecting and tracking these 5 objects from the previous LIDAR point cloud frames. Additionally, the depth clustering at 416 detects and tracks objects outside of or other than the 5 detected objects. This could be, for example, new object(s) that subsequently show up in the field of view. For example only, there could be 2 new objects detected and thus the depth clustering at 416 could be detecting and tracking 7 total objects. Once it is time for the DNN to run again at 424-428, the DNN runs independently and now detects 9 objects in a new or updated ROI. At this point, object association needs to be performed because there are duplicates between the 7 objects previously being detected and tracked by the depth clustering at 416 and the 9 objects independently detected by the DNN. After the association, for example, 7 of the 9 DNN objects could be determined to be the same 7 objects that the depth clustering was detecting and tracking at 416. This association could be as simple as, for example, using a distance between two objects (i.e., if they are close enough, or their distance between is below a threshold, then they can be treated as the same object). The process then continues by depth clustering detecting and tracking the 9 objects at 416.

It will be appreciated that the term “controller” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. An object detection and tracking system for an autonomous driving feature of a vehicle, the system comprising:
a light detection and ranging (LIDAR) system configured to capture LIDAR point cloud data external to the vehicle; and
a controller configured to:
access a deep neural network (DNN) trained for object detection;
run the DNN on the LIDAR point cloud data at a first rate to detect a first set of objects and a region of interest (ROI) comprising the first set of objects; and
depth cluster the LIDAR point cloud data for the detected ROI at a second rate to detect and track a second set of objects comprising the first set of objects and any new objects that subsequently appear in a field of view of the LIDAR system, wherein the second rate is greater than the first rate,
wherein the depth clustering continues until a subsequent second iteration of the DNN is run to thereby accurately detect and track the second set of objects with robustness to noise while also reducing hardware requirements corresponding to the DNN.

2. The system of claim 2, wherein the depth clustering to detect and track the second set of objects comprises performing a procedure comprising:
generating first and second lines from the LIDAR sensor to first and second points in the LIDAR point cloud data for the detected ROI;
generating a third line connecting the first and second points;
determining an angle between the first and third lines; and
determining that the first and second points belong to a same object when the angle exceeds a calibrated threshold.

3. The system 2, wherein the depth clustering to detect and track the second set of objects comprises performing the procedure for a plurality of pairs of points in the LIDAR point cloud data for the detected ROI.

4. The system of claim 1, wherein the controller is further configured to run the DNN again at the first rate to detect a third set of objects and a new or updated ROI comprising the third set of objects.

5. The system of claim 4, wherein the controller is further configured to associate the second and third sets of objects to synchronize the DNN and depth clustering procedures and obtain a fourth set of objects.

6. The system of claim 5, wherein the controller is further configured to restart the depth clustering for the new or updated ROI at the second rate to detect and track a fifth set of objects comprising the fourth set of objects and any new objects that subsequently appear in the field of view of the LIDAR system.

7. The system of claim 1, wherein the first and second rates are calibrated based on a set of vehicle parameters that affect how aggressive object detection and tracking should be performed.

8. The system of claim 7, wherein the set of vehicle parameters comprises vehicle speed.

9. The system of claim 7, wherein the set of vehicle parameters comprises the field of view of the LIDAR system.

10. An object detection and tracking method for a vehicle, the method comprising:
accessing, by a controller of the vehicle, a deep neural network (DNN) trained for object detection;
receiving, by the controller and from a light detection and ranging (LIDAR) system of the vehicle, LIDAR point cloud data external to the vehicle;
running, by the controller, the DNN on the LIDAR point cloud data at a first rate to detect a first set of objects and a region of interest (ROI) comprising the first set of objects; and
depth clustering, by the controller, the LIDAR point cloud data for the detected ROI at a second rate to detect and track a second set of objects comprising the first set of objects and any objects that subsequently appear in a field of view of the LIDAR system, wherein the second rate is greater than the first rate,
wherein the depth clustering continues until a subsequent second iteration of the DNN is run to thereby accurately detect and track the second set of objects with robustness to noise while also reducing hardware requirements corresponding to the DNN.

11. The method of claim 10, wherein the depth clustering to detect and track the second set of objects comprises performing, by the controller, a procedure comprising:
generating first and second lines from the LIDAR sensor to first and second points in the LIDAR point cloud data for the detected ROI;
generating a third line connecting the first and second points;
determining an angle between the first and third lines; and
determining that the first and second points belong to a same object when the angle exceeds a calibrated threshold.

12. The method of claim 11, wherein the depth clustering to detect and track the second set of objects comprises performing, by the controller, the procedure for a plurality of pairs of points in the LIDAR point cloud data for the detected ROI.

13. The method of claim 10, further comprising running, by the controller, the DNN again at the first rate to detect a third set of objects and a new or updated ROI comprising the third set of objects.

14. The method of claim 13, further comprising associating, by the controller, the second and third sets of objects to synchronize the DNN and depth clustering procedures and obtain a fourth set of objects.

15. The method of claim 14, further comprising restarting, by the controller, the depth clustering for the new or updated ROI at the second rate to detect and track a fifth set of objects comprising the fourth set of objects and any new objects that subsequently appear in the field of view of the LIDAR system.

16. The method of claim 10, wherein the first and second rates are calibrated based on a set of vehicle parameters that affect how aggressive object detection and tracking should be performed.

17. The method of claim 16, wherein the set of vehicle parameters comprises vehicle speed.

18. The method of claim 10, wherein the set of vehicle parameters comprises the field of view of the LIDAR system.
